(19) United States
(12) Patent Application Publication
(10) Pub. No.: US 2021/0258619 A1
(43) Pub. Date: Aug. 19, 2021

(54) METHOD FOR PROCESSING LIVE STREAMING CLIPS AND APPARATUS, ELECTRONIC DEVICE AND COMPUTER STORAGE MEDIUM

(71) Applicant: BEIJING DAJIA INTERNET INFORMATION TECHNOLOGY CO., LTD, Beijing (CN)

(72) Inventor: Yang Zhang, Beijing (CN)

(21) Appl. No.: 17/255,875

(22) PCT Filed: Sep. 5, 2019
(86) PCT No.: PCT/CN2019/104516

§ 371 Date: Dec. 23, 2020

(30) Foreign Application Priority Data
Oct. 18, 2018 (CN) 201811217993.2

(51) Int. Cl. H04N 21/2187; H04N 21/233; H04N 21/239; H04N 21/472; H04N 21/482

(52) U.S. Cl. CPC H04N 21/2187; H04N 21/233; H04N 21/4825; H04N 21/47202; H04N 21/2393

(57) ABSTRACT

The disclosure relates to a method for processing live streaming clips, and apparatus, electronic device and computer storage medium. The method includes acquiring an intercepted live streaming clip. The method includes determining a score of the live streaming clip based on the live streaming clip and a scoring mechanism; presenting the live streaming clip based on the score of the live streaming clip. The method includes playing the live streaming clip in response to receiving an on-demand request for the live streaming clip.

### CROSS-REFERENCE TO RELATED APPLICATION

This application is the 371 application of PCT Application No. PCT/CN2019/104516, filed on Sep. 5, 2019, which claims the priority of the Chinese Patent Application No. 201811217993.2, filed with China National Intellectual Property Administration on Oct. 18, 2018, the disclosures of which are herein incorporated by reference in their entireties.

### TECHNICAL FIELD

The disclosure relates to the technical field of mobile Internet, and more particularly, to a method for processing live streaming clips, and apparatus, electronic device and computer storage medium.

### BACKGROUND

With the development of the Internet and communication technology, more and more users choose to webcast or watch a webcast for entertainment as a way of life. In order to meet live streaming needs of users, there are many live streaming rooms in which anchors can sing for the users.

However, in related technologies, most of them are based on a mode of live streaming anchors singing in a schedule. If a present live streaming of a live streaming user ends, other users or viewers cannot watch the same live content repeatedly, and in order to enable other users or viewers to watch the same live content again, the corresponding live streaming user need to perform real-time live streaming again. As a result, the inventor realizes that manual operation cost of existing live streaming method is relatively high, and the viewer cannot watch the same live streaming clip repeatedly, which results in a poor user experience.

The above information is presented as background information only to assist with an understanding of the disclosure. No determination has been made, and no assertion is made, as to whether any of the above might be applicable as prior art with regard to the disclosure.

### SUMMARY

According to a first aspect of the disclosure, there is provided a method for processing live streaming clips, the method includes acquiring an intercepted live streaming clip; determining a score of the live streaming clip based on the live streaming clip and a scoring mechanism; presenting the live streaming clip based on the score of the live streaming clip; and playing the live streaming clip in response to receiving an on-demand request for the live streaming clip.

According to a second aspect of the disclosure, there is provided an apparatus for processing live streaming clips, the apparatus includes: a live streaming clip intercepting module configured to acquire an intercepted live streaming clip; a live streaming clip scoring module configured to determine a score of the live streaming clip based on the live streaming clip and a scoring mechanism; a live streaming clip presenting module configured to present the live streaming clips based on the score of the live streaming clip; and a live streaming clip on-demand playing module configured to play the live streaming clip in response to receiving an on-demand request for the live streaming clip. According to a third aspect of the disclosure, there is provided an electronic device, the electronic device includes: a processor; and a memory for storing instructions executable by the processor. The processor is configured to: acquire an intercepted live streaming clip; determine a score of the live streaming clip based on the live streaming clips and a scoring mechanism; present the live streaming clips based on the score of the live streaming clip; and play the live streaming clip in response to receiving an on-demand request for the live streaming clip.

According to a fourth aspect of the disclosure, there is provided a non-transitory computer-readable storage medium having a computer instruction stored thereon, when the computer instruction being executed by a processor of the electronic device, enable the electronic device to implement any one of the methods for processing live streaming clips according to the first aspect.

It should be understood that the above general description and the following detailed description are only exemplary and explanatory, and do not limit the disclosure.

### BRIEF DESCRIPTION OF THE DRAWINGS

FIG. 1 is a flow chart showing a method for processing live streaming clips according to an arrangement of the disclosure;

FIG. 2 is a schematic diagram showing a way of presenting live streaming clips according to an arrangement of the disclosure;

FIG. 3A is a schematic diagram showing a live streaming interface when applying for an interception according to an arrangement of the disclosure;

FIG. 3B is a schematic diagram showing a live streaming interface for displaying prompt information according to an arrangement of the disclosure;

FIG. 4A is a schematic diagram showing a playing interface of a live streaming clip according to an arrangement of the disclosure;

FIG. 4B is a schematic diagram showing a playing interface indicating that a live streaming user is in live streaming according to an arrangement of the disclosure;

FIG. 5 is a block diagram showing an apparatus for processing live streaming clips according to an arrangement of the disclosure;

FIG. 6 is a block diagram showing a device according to an arrangement of the disclosure;

FIG. 7 is a block diagram showing a device according to an arrangement of the disclosure.

### DETAILED DESCRIPTION

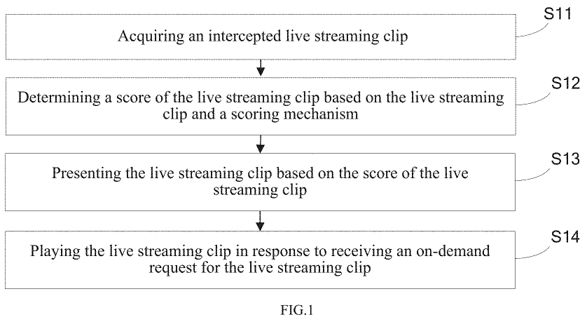

FIG. 1 is a flow chart showing a method for processing live streaming clips according to an arrangement of the disclosure. As shown in FIG. 1, the method for processing live streaming clips can be configured in a terminal and includes the following blocks.

In block S11, an intercepted live streaming clip is acquired. In some arrangements, one or more live streaming clips can be intercepted.

As mentioned above, the existing live streaming method cannot repeat an on-demand play for completed live content, resulting in a poor user experience. In the arrangement of the disclosure, in order to enable the completed live content to be on-demand played again, the live content can be intercepted during the live streaming. As such, an intercepted live streaming clip can be acquired. Moreover, since a part that the user is interested during one live streaming may be only a part of the live streaming, of course, the part that the user is interested may also be live content during the whole live streaming process, so the live content can be intercepted in a targeted manner to obtain a personalized live streaming clip.

For example, the intercepted live streaming clips can be acquired by using any available method, which is not limited in the arrangements of the disclosure. For example, for an anchor who may want to share his or her live content repeatedly, the anchor can intercept the live content during the live streaming in a custom way to obtain corresponding live streaming clips. Alternatively, a live platform can intercept the live content according to the anchor who is in a live-streaming. Alternatively, the viewers watching the live streaming can intercept the live content which is live-streamed, and so on.

In addition, when an anchor is in live streaming, users who watch the live streaming in real time can also interact with the anchor in real time by giving a like, giving a gift by swiping user' card, leaving messages, etc., so when the live content is intercepted, real-time interactions in corresponding clips can also be acquired. Of course, it can be set that do not acquire corresponding real-time interactive content, but only to acquire the live content of the anchor, which is not limited in the arrangements of the disclosure.

In block S12, a score value of intercepted live streaming clip is determined based on the intercepted live streaming clip and a preset scoring mechanism.

After acquiring one or more intercepted live streaming clips, the live streaming clips may be presented. Since a plurality of different live streaming clips can be obtained, there is a problem of presenting the different live streaming clips in what order of preference during a presentation process. In order to give priority to the live streaming clips having better live streaming effects, that is, present better live streaming clips preferentially, a score value of each of the different intercepted live streaming clips can be further determined respectively according to the intercepted live streaming clips and the preset scoring mechanism. The scoring mechanism can be preset according to requirements, which is not limited in the arrangements of the disclosure. For example, for live streaming clips of a singing live streaming, a scoring mechanism can be set to compare live streaming vocal audio in the live streaming clip with a corresponding original singing audio, and then determine a score value of the corresponding singing live streaming clip according to a match degree between these two audio. Alternatively, the score value of the live streaming clip may also be determined according to popularity of the corresponding live streaming clip during the real-time live streaming, and so on. The popularity can be comprehensively evaluated by the number of real-time viewers, the number of likes, the number of swiped gifts, and the amount of comment data. Moreover, according to the different scoring mechanism, the score values of the intercepted live streaming clips can be determined by using a corresponding available method, which is not limited in the arrangements of the disclosure.

In block S13, the live streaming clips are presented based on the score values of the intercepted live streaming clips.

After determining the score value of each of the intercepted live streaming clips, the live streaming clips can be presented according to corresponding score value of each of the live streaming clips. For example, a live streaming clip with higher score can be presented first. Alternatively, at least one live streaming clip with scores above a preset score can be set as one or more selected clips (“good clips”), and the selected clips can be recommended to various electronic devices in polling play mode in the live streaming room to attract users or viewers to watch. The preset score can be preset according to requirements, which is not limited in the arrangements of the disclosure.

Moreover, when presenting the live streaming clips, a cover of each of the live streaming clips can be presented by way of a list, in which the cover of the live streaming clip can be a first frame image in the corresponding live streaming clip, or can be a cover customized by different users, and so on. For example, the cover can be preset according to requirements, which is not limited in the arrangement of the present disclosure.

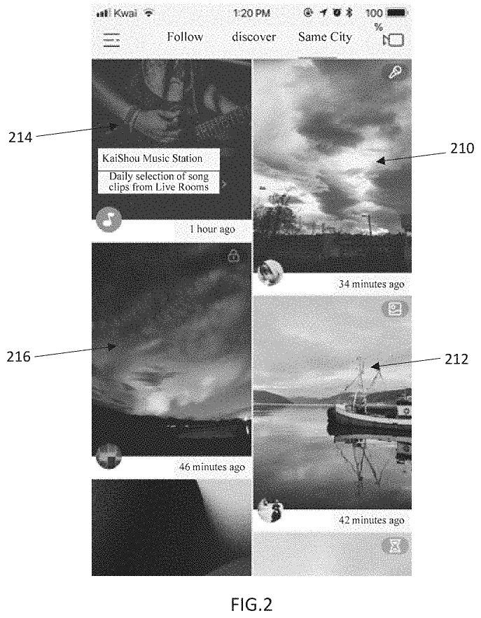

FIG. 2 shows a way of presenting the live streaming clips based on scores. The selected clips 210, 212, 214, 216 corresponding to current date can be contained in a “KaiShou Music Station”, which preferentially presented those selected clips 210, 212, 214, 216. Moreover, in the arrangements of the disclosure, since different anchors may conduct live streaming in different time periods, and different live streaming clips can be acquired constantly, so an update period for the live streaming clips can be set, and then presented live streaming clips can be updated once within each update period. The update period for the live streaming clips can be preset according to requirements, which is not limited in the arrangements of the disclosure. For example, the update period for the live streaming clips may be set to one hour, or one day, and so on.

In block S14, in response to receiving an on-demand request for the intercepted live streaming clip, the live streaming clip is played.

After the live streaming clips are presented, users of different electronic devices can browse a presentation page through corresponding electronic devices, and perform the on-demand request for the live streaming clip, which is a live streaming clip user being interested in. Therefore, in the arrangements of the disclosure, an on-demand request for live streaming clip can be received, and the corresponding live streaming clip can be played.

Furthermore, the user can input an on-demand request for a live streaming clip through an electronic device in any available manner, which is not limited in the arrangements of the disclosure. For example, an on-demand request for a certain live streaming clip can be conducted by clicking a cover of the corresponding live streaming clip, or if user is not satisfied with a live streaming clip currently being played, then user can switch to a next live streaming clip by sliding, trigger on-demand request for a next live streaming clip by sliding, etc.

In the arrangements of the disclosure, the block S11 may further include the following blocks.

In block S111, in response to an interception application request for current live streaming, an intercepted live streaming clip of the current live streaming is acquired;

And/or, in block S112, a current singing live streaming is detected, and a intercepted live streaming clip including a complete song live streaming clip in the singing live streaming are acquired.

In the arrangements of the disclosure, in order to meet sharing need of the anchor himself/herself repeatedly playing the live content, or the need of the live streaming viewer repeatedly watching the current live content, etc., current anchor (who is conducting a live-streaming now) or current viewers (who are watching now) can actively send an interception application request for the current live streaming, and then an intercepted live streaming clip of the current live streaming can be obtained according to the interception application request for the current live streaming. The interception application request refers to a request applying for conducting an interception. Moreover, an interception range for the live streaming clip obtained by intercepting the current live streaming can be customized by an initiator of a corresponding interception application request. For example, the interception scope for the present interception can be directly set in the interception application request, and so on. If the interception range is not customized, then the live content can be directly intercepted according to the interception range set by the corresponding live platform, or the live content can be fully intercepted, and so on.

For example, when an anchor is currently in a singing live streaming, if said anchor actively triggers an interception application request for the current live streaming, and the interception range is set climax parts of the song, at this point only the climax parts of the current singing live streaming can be intercepted as live streaming clips, i.e. the intercepted live streaming clips. If the interception range is not set and the interception range set by the corresponding live platform is a complete song, at this point a plurality of complete songs in the live content can be intercepted as the corresponding live streaming clips.

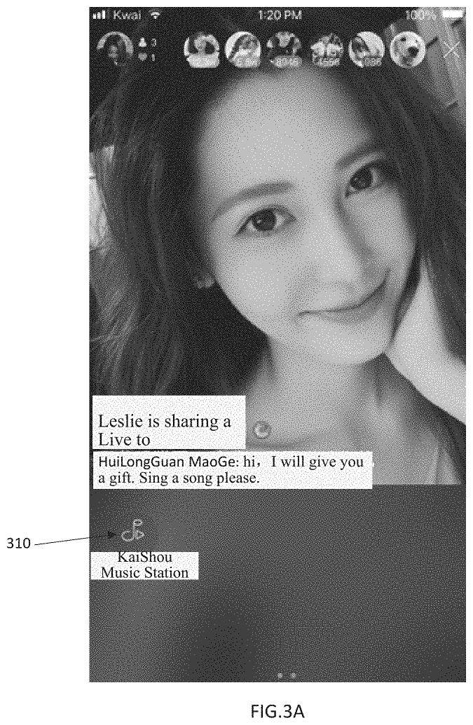

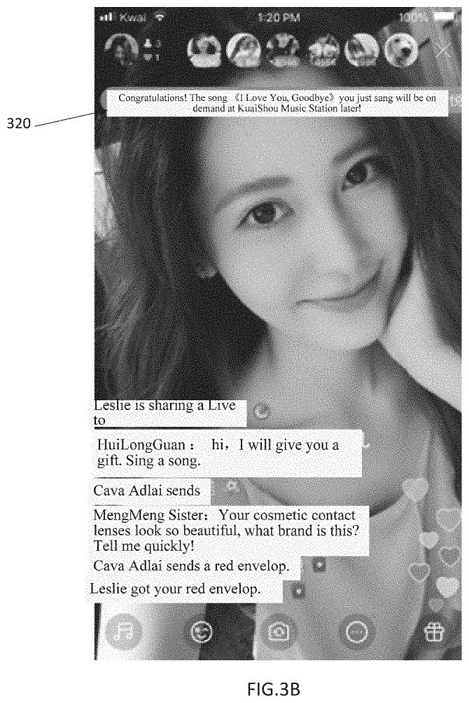

Moreover, in the arrangements of the disclosure, the interception application request can be issued by any available method, and the specific setting can be preset according to the requirements, which is not limited by the arrangements of the disclosure. As shown in FIG. 3A, a ‘Music Station Application’ control can be disposed in a live streaming interface of the current live streaming. The anchor or viewer and so on of the current live streaming can actively trigger an interception application request by clicking the ‘Music Station Application’ control 310, and after triggering of the interception application request, corresponding prompt information can also be displayed on the live streaming interface to inform the corresponding anchor or other viewers that the current live streaming has been intercepted to get live streaming clips. The format of the prompt information can be preset according to requirements, which is not limited in the arrangements of the disclosure. For example, prompt information 320 shown in FIG. 3B ‘Congratulations! The song Love You, Goodbye)) you just sang will be on demand at KuaiShou Music Station later!’ and so on.

In addition, for the live platform, in order to attract more users, it is possible to detect the current singing live streaming, and obtain a complete song live streaming clip of the singing live streaming as a kind of live streaming clip. Moreover, the complete song live streaming clip may be a song live streaming clip including an intro part, or a song live streaming clip that does not include the intro part. Specifically, it can be preset according to requirements, which is not included in this arrangement of the application.

In the arrangements of the disclosure, block S12 may further include the following blocks.

In block S121, in response to the intercepted live streaming clip is a song live streaming clip, live streaming vocal audio is extracted from audio data of the intercepted live streaming clip;

In block S122, the score value of the live streaming clip is determined based on the live streaming vocal audio and the preset scoring mechanism.

For the song live streaming clip, the background music is generally provided by the live platform or obtained through the network, and it is not the content recorded by users in real time. Moreover, the audio-visual effects of the background music are generally good, which easily affects the judgment of vocal audio in the song live streaming clips. Therefore, in order to improve the objectivity and accuracy of the score value of each of live streaming clips, in the arrangements of the disclosure, the score value of the corresponding live streaming clip may be determined only based on the live streaming vocal audio of the song live streaming clip through a preset scoring mechanism. Furthermore, for the song live streaming clip, the live streaming vocal audio can be extracted from the audio data of the song live streaming clip. For example, the live streaming vocal audio can be extracted from the audio data by any available method, which is not limited in the arrangements of the disclosure. In the disclosure, the live streaming vocal audio is original voice of a corresponding anchor in the song live streaming clip.

In turn, the score value of the corresponding song live streaming clip can be determined based on the extracted live streaming vocal audio and the preset scoring mechanism.

In the arrangements of the disclosure, block S14 may further include the following blocks.

In block S141, in response to receiving the on-demand request for the live streaming clip, a latest on-demand record in connection with the live streaming clip on a third-party electronic device corresponding to the on-demand request is acquired.

In practical applications, if the user is interested in a certain live streaming clip, he or she may request playing the same live streaming clip for multiple times. In the case of that in a previous playing of the live streaming clip, user may not watch the corresponding live streaming clip to the end, and when the same live streaming clip is played again, it tends to continue watching from a stopping position in the previous playing. When the user needs to manually adjust a viewing progress to the stopping position in the previous playing, it wastes user time and the accuracy of manual adjustment is not high.

Therefore, in the arrangements of the disclosure, in order to avoid the above situation and further improve the user's viewing experience, in response to receiving an on-demand request for a live streaming clip, a third-party electronic device corresponding to said on-demand request may be acquired, or an on-demand record regarding to the most recent on-demand playing for the live streaming clip of user corresponding to said on-demand request may be acquired.

Moreover, it can be seen from the above that in the arrangements of the disclosure, after on-demand playing for a certain live streaming clip, an on-demand record of the electronic device for the live streaming clip can also be recorded by the electronic device, and the on-demand record can include an stopping position of playing the corresponding live streaming clip via the corresponding electronic device, that is an stopping position of audiovisual playing, and so on. In addition, in order to reduce the waste of storage space, only the most recent on-demand record can be stored. Of course, all on-demand records can also be recorded, which can be preset according to requirements. This is not limited in the arrangements of the disclosure.

In block S142, based on the on-demand record, a stopping position of a previous audiovisual playing for the live streaming clip in the third-party electronic device is determined.

As mentioned above, the on-demand record can include the stopping position of the audiovisual in each on-demand playing. Therefore, the stopping position of the previous audiovisual playing of a corresponding third-party electronic device for the corresponding live streaming clip is determined according to the on-demand record of the corresponding third-party electronic device. That is, a stopping time of the latest audiovisual playing can be determined in the on-demand record. If, in the on-demand record, the stopping position of the previous audiovisual playing of the third-party electronic device for the live streaming clip cannot be determined, it is defaulted to play from a start position of the corresponding live streaming clip, i.e. play the live streaming clip from the beginning.

In block S143, the live streaming clip is played continually starting from the stopping position of the previous audiovisual playing.

Furthermore, the live streaming clip may continue to play from the stopping position of the previous audiovisual playing. For example, if it is determined that the stopping position of the previous audiovisual playing is at a position of 4 minutes and 30 seconds, then at this point the live streaming clip may be played continuously from the position of 4 minutes and 30 seconds of the corresponding live streaming clip. If the stopping position of the previous audiovisual playing is defaulted as a start position of the corresponding live streaming clip (i.e. the beginning of the corresponding live streaming clip), then at this point the corresponding live streaming clip can be replay from the beginning.

In the arrangements of the disclosure, after block S14, the method may further include the following blocks.

In block S15, an interactive operation on the live streaming clip is recorded.

When the user watches a certain live streaming clip, he or she can also perform an interactive operation on the live clip, such as giving a like, collecting, making comments, and so on. Furthermore, in order to make the corresponding anchor to obtain user' feedback effects for the live streaming clip in time, the interactive operations of each of live streaming clips can be recorded.

In block S16, whether or not a user corresponding to the live streaming clip is conducting live streaming is detected. The user is an anchor or person who live-streamed said live streaming clip.

In block S17, in response to the user is in a live-streaming, an interactive operation record regarding to one or more interactive operations of said live streaming clip is sent to the user, and/or in a live streaming interface of said live streaming clip, it is displayed that the user is in a live-streaming, that is the user is conducting a live streaming.

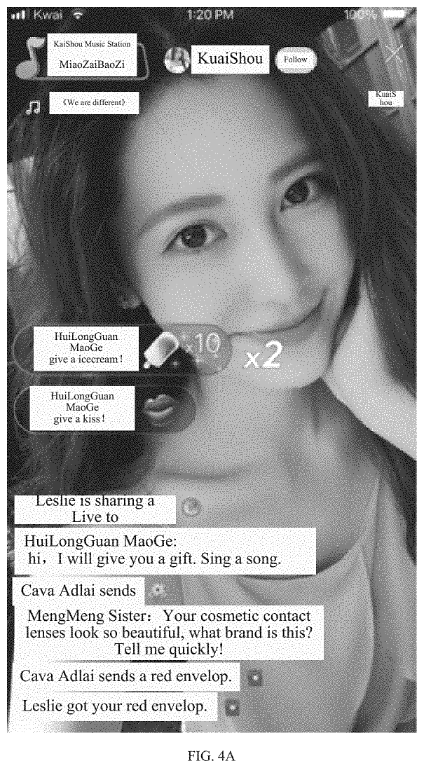

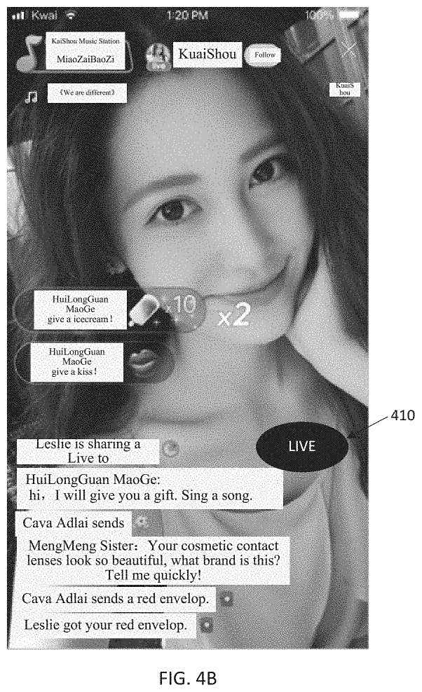

Moreover, in order to attract more viewers to the corresponding anchor and increase the exposure of the anchor, when or in response to a certain live streaming clip is played by a user, whether or not the user of the corresponding live streaming clip is currently in the live-streaming is detected. If the corresponding user is in the live-streaming, the interactive operation record of the corresponding live streaming clip can be sent to the corresponding user, and/or in the live streaming interface of said live streaming clip, it is displayed that the user is conducting live streaming. Moreover, a way of displaying that the user is in the live-streaming can be preset according to requirements, which is not limited in the arrangements of the disclosure. For example, for the live streaming interface of the live streaming clip shown in FIG. 4A, a “Live” icon 410 may be displayed outside user's head portrait to indicate that the corresponding user is in a live-streaming, as shown in FIG. 4B. Furthermore, by detecting whether or not user identification (ID) of the corresponding live streaming clip is in a live streaming state, it can be determined whether or not the corresponding user is in a live-streaming. The user identification (ID) of the live streaming clip can be understood as the user ID of the live streaming user corresponding to the corresponding live streaming clip.

In block S18, in response to receiving a trigger operation for a head portrait of the user of the live streaming clip is received, it is switched to a real-time live streaming interface of the user.

If the user of said live streaming clip is in the live-streaming, other users can input a trigger operation to the head portrait of the user for the live streaming clip, thereby quickly switching to the real-time live streaming interface of the corresponding user.

For example, for the playing interface of the live streaming clip shown in FIG. 4B, the trigger operation can be input by clicking on the user's head portrait in the live streaming interface, thereby switching to the real-time live streaming interface of the corresponding user.

In the arrangements of the disclosure, it is possible to acquire an intercepted live streaming clip; determine a score value of the live streaming clip according to the live streaming clip and a preset scoring mechanism; present the live streaming clip according to the score value of the live streaming clip; and receive an on-demand request for the live streaming clip and play the live streaming clip. Therefore, beneficial effect of reducing labor operating costs is achieved, while meeting users' repeated viewing demands and improving the user experience.

Moreover, in the arrangements of the disclosure, it is also possible to acquire the live streaming clip of the current live streaming according to an interception application request for a current live streaming; and/or detect a current singing live streaming, and acquiring a complete song live streaming clip in the current singing live streaming. Therefore, the comprehensiveness of the intercepted live streaming clips can be improved, and the number of users can be further increased.

In addition, in the arrangements of the disclosure, it is also possible to extract live streaming vocal audio from audio data of each live streaming clip, if the live streaming clip is a song live streaming clip; determine the score value of the live streaming clip based on the live streaming vocal audio and a preset scoring mechanism. Therefore, the accuracy of the score value of the live streaming clip can be improved.

Furthermore, in this arrangements of the application, it is also possible to acquire a latest on-demand record in connection with the live streaming clip on a third-party electronic device corresponding to the on-demand request, when an on-demand request for the live streaming clip is received; determine a stopping position of a previous audiovisual playing for said live streaming clip in the third-party electronic device according to the on-demand record; continue to play said live streaming clip starting from the stopping position of the previous audiovisual playing for said live streaming clip, which can further improve the user's audiovisual experience.

Furthermore, in this arrangements of the application, it is also possible to record an interactive operation on said live streaming clip; detect whether or not a user corresponding to said live streaming clip is in the live-streaming; if the user is in the live-streaming, send an interactive operation record about the interactive operation of said live streaming clip to the user, send the interactive operation record to the user, and/or display that the user is in the live-streaming in a live streaming interface of said live streaming clip. Furthermore, when a trigger operation to a head portrait of the user who is in a live-streaming is received, it is possible to switch to a real-time live streaming interface of the user. Therefore, the exposure of the anchor and the number of users of the live platform are improved, while improving the user's audiovisual experience.

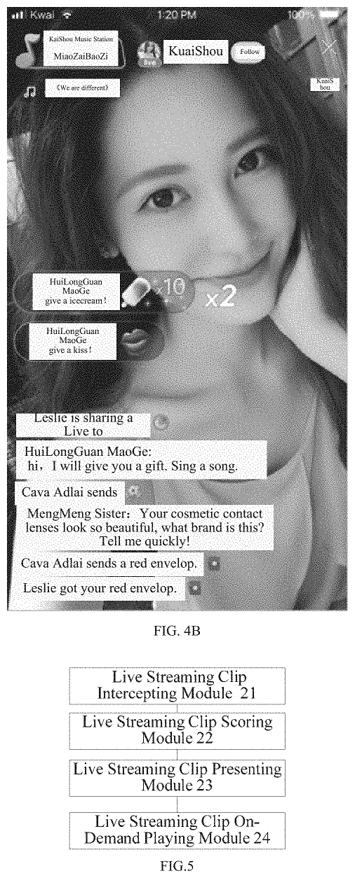

FIG. 5 is a block diagram showing an apparatus for processing live streaming clips according to an arrangement of the disclosure. Referring to FIG. 5, the apparatus includes a live streaming clip intercepting module 21, a live streaming clip scoring module 22, a live streaming clip presenting module 23, and a live streaming clip on-demand playing module 24.

The live streaming clip intercepting module 21 is configured to acquire an intercepted live streaming clip.

The live streaming clip scoring module 22 is configured to determine a score of the live streaming clip based on the live streaming clip and a scoring mechanism.

The live streaming clip presenting module 23 is configured to present the live streaming clip based on the score of the live streaming clip.

The live streaming clip on-demand playing module 24 is configured to play the live streaming clip in response to receiving an on-demand request for the live streaming clip.

In the arrangements of the disclosure, the live streaming clip intercepting module 21 may further include a first live streaming clip intercepting sub-module and a second live streaming clip intercepting sub-module.

The first live streaming clip intercepting sub-module is configured to acquire the live streaming clip of current live streaming in response to an interception application request for the current live streaming;

And/or, the second live streaming clip intercepting sub-module is configured to detect a current singing live streaming, and acquiring the live streaming clip that includes a complete song live streaming clip in the current singing live streaming.

In the arrangements of the disclosure, the live streaming clip scoring module 22 may further include a vocal audio extraction sub-module and a live streaming clip scoring sub-module.

The vocal audio extraction sub-module is configured to: in response to the live streaming clip being a song live streaming clip, extract live streaming vocal audio from audio data of the live streaming clip.

The live streaming clip scoring sub-module is configured to determine the score of the live streaming clip based on the live streaming vocal audio and the scoring mechanism.

In the arrangements of the disclosure, the live streaming clip on-demand module 24 may further include an on-demand record acquisition sub-module, an audiovisual stopping position confirmation sub-module and a live streaming clip on-demand sub-module.

The on-demand record acquisition sub-module is configured to acquire a latest on-demand record for the live streaming clip on a third-party electronic device corresponding to the on-demand request in response to receiving the on-demand request for the live streaming clip.

The audiovisual stopping position confirmation sub-module is configured to determine a stopping position of a previous audiovisual playing for the live streaming clip on the third-party electronic device based on the on-demand record.

The live streaming clip on-demand sub-module is configured to play the live streaming clip starting from the stopping position of the previous audiovisual playing continually.

In the arrangements of the disclosure, the apparatus for processing live streaming clips may further include an interactive operation recording module, a live streaming detection module, an interactive operation record sending module and/or a live streaming state display module, as well as a live streaming interface switching module.

The interactive operation recording module is configured to record an interactive operation on the live streaming clip.

The live streaming detection module is configured to detect whether or not a user corresponding to the live streaming clip is in a live-streaming.

The interactive operation record sending module is configured to send an interactive operation record of the live streaming clip to the user based on the user is in a live-streaming, and/or.

The live streaming state display module is configured to display that the user is in the live-streaming in a live streaming interface of the live streaming clip, based on the user is in a live-streaming.

The live streaming interface switching module is configured to in response to receiving a trigger operation for a head portrait of the user of the live streaming clip, switch to a real-time live streaming interface of the user.

In the arrangements of the disclosure, it is possible to acquire an intercepted live streaming clip; determine a score of the live streaming clip based on the live streaming clip and a scoring mechanism; present the live streaming clip based on the score of the live streaming clip; and play the live streaming clip in response to receiving an on-demand request for the live streaming clip. Therefore, beneficial effect of reducing labor operating costs is achieved, while meeting users' repeated viewing demands and improving the user experience.

Moreover, in the arrangements of the disclosure, it is also possible to acquire the live streaming clip of current live streaming in response to an interception application request for the current live streaming; and/or detect a current singing live streaming, and acquiring the live streaming clip that includes a complete song live streaming clip in the current singing live streaming. Therefore, the comprehensiveness of the intercepted live streaming clips can be improved, and the number of users can be further increased.

In addition, in the arrangements of the disclosure, it is also possible to in response to the live streaming clip being a song live streaming clip, extract live streaming vocal audio from audio data of the live streaming clip; determine the score of the live streaming clip based on the live streaming vocal audio and the scoring mechanism. Therefore, the accuracy of the score values of the live streaming clips can be improved.

Furthermore, in this arrangements of the application, it is also possible to acquire a latest on-demand record for the live streaming clip on a third-party electronic device corresponding to the on-demand request in response to receiving the on-demand request for the live streaming clip; determine a stopping position of a previous audiovisual playing for the live streaming clip on the third-party electronic device based on the on-demand record; and play the live streaming clip starting from the stopping position of the previous audiovisual playing continually, which can further improve the user's audiovisual experience.

Furthermore, in this arrangements of the application, it is also possible to record an interactive operation on the live streaming clip; detect whether or not a user corresponding to the live streaming clip is in a live-streaming; and based on the user is in a live-streaming, sending an interactive operation record of the live streaming clip to the user, and/or displaying that the user is in the live-streaming in a live streaming interface of the live streaming clip. Furthermore, when a trigger operation to a head portrait of the user who is in the live-streaming is received, it is possible to switch to a real-time live streaming interface of the user. Therefore, the exposure of the anchor and the number of users of the live platform are improved, while improving the user's audiovisual experience.

Regarding the apparatus in the foregoing arrangement, the specific manner in which each module performs the operation has been described in detail in the arrangement of the method, and detailed description will not be given here.

In addition, the arrangements of the disclosure also disclose an electronic device. The electronic device includes a processor and a memory configured to store instructions executable by the processor.

Furthermore, the processor is configured to: acquire an intercepted live streaming clip; determine a score of the live streaming clip based on the live streaming clip and a scoring mechanism; present the live streaming clip based on the score of the live streaming clip; and play the live streaming clip in response to receiving an on-demand request for the live streaming clip.

In the arrangements of the disclosure, the processor is configured to acquire the live streaming clip of current live streaming in response to an interception application request for the current live streaming; and/or detect a current singing live streaming, and acquire the live streaming clip that includes a complete song live streaming clip in the current singing live streaming.

In the arrangements of the disclosure, the processor is configured to in response to the live streaming clip being a song live streaming clip, extract live streaming vocal audio from audio data of the live streaming clip; and determine the score of the live streaming clip based on the live streaming vocal audio and the scoring mechanism.

In the arrangements of the disclosure, the processor is configured to acquire a latest on-demand record for the live streaming clip on a third-party electronic device corresponding to the on-demand request in response to receiving the on-demand request for the live streaming clip; determine a stopping position of a previous audiovisual playing for the live streaming clip on the third-party electronic device based on the on-demand record; and play the live streaming clip starting from the stopping position of the previous audiovisual playing continually.

In the arrangements of the disclosure, the processor is further configured to after playing the live streaming clip in response to receiving an on-demand request for the live streaming clip, record an interactive operation on the live streaming clip; detect whether or not a user corresponding to the live streaming clip is in a live-streaming; and based on the user is in the live-streaming, send an interactive operation record of the live streaming clip to the user, and/or display that the user is in the live-streaming in a live streaming interface of the live streaming clip.

In the arrangements of the disclosure, the processor is further configured to after displaying that the user is in the live-streaming in the live streaming interface of the live streaming clip, in response to receiving a trigger operation for a head portrait of the user of the live streaming clip, switch to a real-time live streaming interface of the user.

The arrangements of the disclosure also discloses a non-transitory computer-readable storage medium having a computer instruction stored thereon. When the computer instruction is executed by a processor of the electronic device, enable the electronic device to implement any one of the methods for processing live streaming clips mentioned above.

The arrangements of the disclosure also disclose an application program/computer program product. When instructions in the application program/computer program product are executed by the processor of the electronic device, enable the electronic device to implement any one of the methods for processing live streaming clips mentioned above.

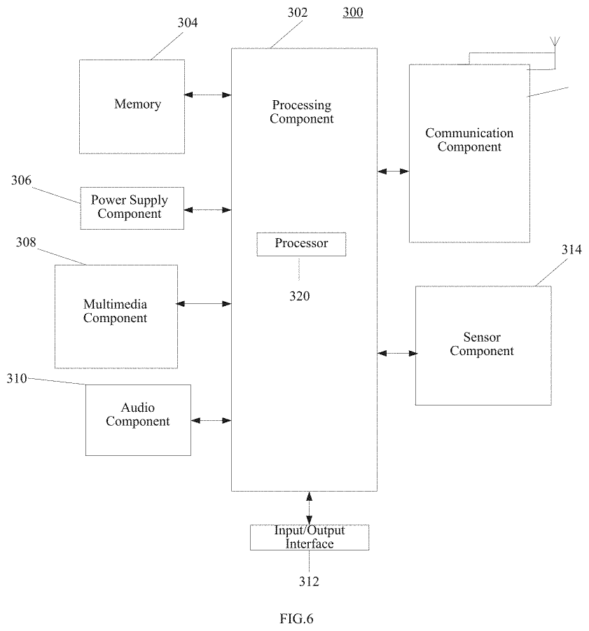

FIG. 6 is a block diagram showing an electronic device 300 configured for processing live streaming clips according to an exemplary arrangement. For example, the electronic device 300 may be a mobile phone, a computer, a digital broadcasting terminal, a messaging device, a game console, a tablet device, a medical device, a fitness device, a personal digital assistant, etc.

Referring to FIG. 6, the electronic device 300 may include one or more of the following components: a processing component 302, a memory 304, a power supply component 306, a multimedia component 308, an audio component 310, and an input/output (I/O) interface 312, a sensor component 314, and a communication component 316.

The processing component 302 generally controls overall operations of the electronic device 300, such as operations associated with display, telephone calls, data communications, camera operations, and recording operations. The processing component 302 may include one or more processors 320 to execute instructions, so as to complete all or part of the steps of the foregoing method. In addition, the processing component 302 may include one or more modules to facilitate the interaction between the processing component 302 and other components. For example, the processing component 3602 may include a multimedia module to facilitate the interaction between the multimedia component 308 and the processing component 302.

The memory 304 is configured to store various types of data to support operations in the electronic device 300. Examples of these data include instructions for any application or method operating on the electronic device 300, contact data, phone book data, messages, pictures, videos, etc. The memory 304 may be implemented by any type of volatile or non-volatile storage device or a combination thereof, such as Static Random-Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk or optical disk.

The power supply component 306 provides power for various components of the electronic device 300. The power supply component 306 may include a power supply management system, one or more power supplies, and other components associated with the generation, management, and distribution of power for the electronic device 300.

The multimedia component 308 includes a screen that provides an output interface between the electronic device 300 and the user. In some arrangements, the screen may include a Liquid Crystal Display (LCD) and a Touch Panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of a touch operation or a slide operation, but also detect duration and pressure related to the touch or slide operation. In the arrangements of the disclosure, the multimedia component 308 includes a front camera and/or a rear camera. When the electronic device 300 is in an operation mode, such as a shooting mode or a video mode, the front camera and/or the rear camera can receive external multimedia data. Each front camera and rear camera can be a fixed optical lens system or have focal length and optical zoom ability.

The audio component 310 is configured to output and/or input audio signals. For example, the audio component 310 includes a microphone (MIC). When the electronic device 300 is in an operation mode, such as a call mode, a recording mode, and a voice recognition mode, the microphone is configured to receive an external audio signal. The received audio signal can be further stored in the memory 304 or sent via the communication component 316. In the arrangements of the disclosure, the audio component 310 further includes a speaker for outputting audio signals.

The I/O interface 312 provides an interface between the processing component 302 and a peripheral interface module. The above-mentioned peripheral interface module may be a keyboard, a click wheel, a button, and the like. These buttons may include but are not limited to a home button, a volume button, a start button, and a lock button.

The sensor component 314 includes one or more sensors for providing the electronic device 300 with various aspects of state evaluation. For example, the sensor component 314 can detect the on/off status of the electronic device 300 and the relative positioning of the components. For example, the component is the display and the keypad of the electronic device 300. The sensor component 314 can also detect the electronic device 300, position change of any of the components in electronic device 300, the presence or absence of contact between the user and the electronic device 300, the orientation or acceleration/deceleration of the electronic device 300, and the temperature change of the electronic device 300. The sensor component 314 may include a proximity sensor configured to detect the presence of nearby objects when there is no physical contact. The sensor component 314 may also include a light sensor for use in imaging applications, such as a Complementary Metal Oxide Semiconductor (CMOS) image sensor or a Charge-coupled Device (CCD) image sensor. In the arrangements of the disclosure, the sensor component 314 may also include an acceleration sensor, a gyroscope sensor, a magnetic sensor, a pressure sensor or a temperature sensor.

The communication component 316 is configured to facilitate wired or wireless communication between the electronic device 300 and other devices. The electronic device 300 can access a wireless network based on a communication standard, such as WiFi, an operator network (such as 2G, 3G, 4G, or 5G), or a combination thereof. In an exemplary arrangement, the communication component 316 receives a broadcast signal or broadcast related information from an external broadcast management system via a broadcast channel. In the arrangements of the disclosure, the communication component 316 further includes a Near Field Communication (NFC) module to facilitate short-range communication. For example, the NFC module can be implemented based on Radio Frequency Identification (RFID) technology, Infrared Data Association (IrDA) technology, Ultra Wide Band (UWB) technology, Bluetooth (BT) technology and other Technology.

In an exemplary arrangement, the electronic device 300 may be implemented by one or more Application Specific Integrated Circuits (ASIC), Digital Signal Processor (DSP), and Digital Signal Processor Device (DSPD), Programmable Logic Device (PLD), Field Programmable Gate Array (FPGA), controller, microcontroller, microprocessor or other electronic components, in order to perform the above methods.

In the arrangements of the disclosure, there is also provided a non-transitory computer-readable storage medium having instructions, such as the memory 304 including instructions, which can be executed by the processor 320 of the electronic device 300 to complete the foregoing method. For example, the non-transitory computer-readable storage medium may be ROM, Random Access Memory (RAM), Compact Disc Read-Only Memory (CD-ROM), magnetic tape, floppy disk, and optical data storage device, etc.

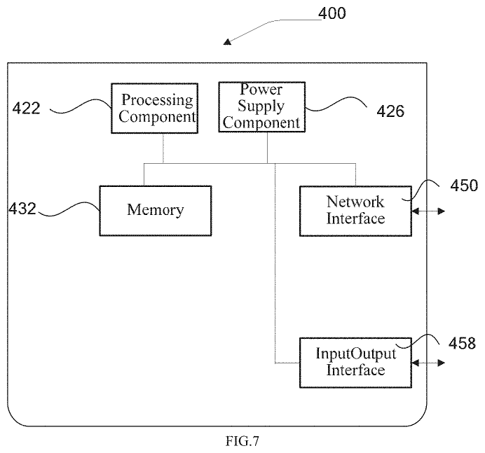

FIG. 7 is a block diagram showing an electronic device 400 configured for processing live streaming clips according to an exemplary arrangement. For example, the electronic device 400 may be provided as a server. Referring to FIG. 7, the electronic device 400 includes a processing component 422, which further includes one or more processors, and a memory resource represented by a memory 432, for storing instructions executable by the processing component 422, such as an application program. The application program stored in the memory 432 may include one or more modules, each of the modules corresponds to a set of instructions. In addition, the processing component 422 is configured to execute instructions to execute the method for processing live streaming clips described above.

In the arrangements of the disclosure, the method for processing live streaming clips may include acquiring one or more intercepted live streaming clips; determining scores of the live streaming clips based on the live streaming clips and a scoring mechanism; presenting the live streaming clips based on the scores of the live streaming clips; and playing said live streaming clip in response to receiving an on-demand request for one of the live streaming clips.

The electronic device 400 may also include a power supply component 426 configured to perform power supply management of the electronic device 400, a wired or wireless network interface 450 configured to connect the electronic device 400 to a network, and an input output (I/O) interface 458. The electronic device 400 can operate based on an operating system stored in the memory 432, such as Windows Server™, Mac OS X™, Unix™, Linux™, FreeBSD™ or the like.

As used in this application and claims, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same arrangement or implementation unless described as such.

It should be noted that the execution subject of this application can be a mobile phone, a computer, a digital broadcasting terminal, a messaging device, a game console, a tablet device, a medical device, a fitness device, a personal digital assistant, etc.; it can also be a server. When electronic devices are devices such as mobile phones, computers, digital broadcasting terminals, messaging devices, game consoles, tablet devices, medical equipment, fitness equipment, personal digital assistants, etc., it is shown as in FIG. 6. When the electronic device is a server, it is shown as in FIG. 7.

1. A method for processing live streaming clips, comprising:
acquiring an intercepted live streaming clip;
determining a score of the live streaming clip based on the live streaming clip and a scoring mechanism, said determining comprising determining the score of the live streaming clip based on popularity of the live streaming clip during a real-time live streaming;
presenting the live streaming clip based on the score of the live streaming clip;
playing the live streaming clip in response to receiving an on-demand request for the live streaming clip
recording an interactive operation on the live streaming clip;
detecting whether or not a user corresponding to the live streaming clip is in a live-streaming; and
based on the user being in a live-streaming, sending an interactive operation record of the live streaming clip to the user, and/or displaying that the user is in the live-streaming in a live streaming interface of the live streaming clip.

2. The method according to claim 1, wherein said acquiring an intercepted live streaming clip comprising:
acquiring the live streaming clip of a current live streaming in response to an interception application request for the current live streaming; and/or
detecting a current singing live streaming, and acquiring the live streaming clip comprising a complete song live streaming clip in the current singing live streaming.

3. The method according to claim 1, wherein said determining the score of the live streaming clip comprising:
in response to the live streaming clip being a song live streaming clip, extracting live streaming vocal audio from audio data of the live streaming clip; and
determining the score of the live streaming clip based on the live streaming vocal audio and the scoring mechanism.

4. The method according to claim 1, wherein said playing the live streaming clip comprising:
acquiring a latest on-demand record for the live streaming clip on a third-party electronic device corresponding to the on-demand request in response to receiving the on-demand request for the live streaming clip;
determining a stopping position of a previous audiovisual playing for the live streaming clip on the third-party electronic device based on the on-demand record; and
playing the live streaming clip starting from the stopping position of the previous audiovisual playing continually.

5. (canceled)

6. The method according to claim 1, wherein after displaying that the user is in the live-streaming in the live streaming interface of the live streaming clip, the method further comprising:
in response to receiving a trigger operation for a head portrait of the user of the live streaming clip, switching to a real-time live streaming interface of the user.

7. (canceled)

8. An electronic device, comprising:
a processor;
a memory for storing instructions executable by the processor;
wherein the processor is configured to:
acquire an intercepted live streaming clip;
determine a score of the live streaming clip based on the live streaming clip and a scoring mechanism, said determine comprising determine the score of the live streaming clip based on popularity of the live streaming clip during a real-time live streaming;
present the live streaming clip based on the score of the live streaming clip;
play the live streaming clip in response to receiving an on-demand request for the live streaming clip
record an interactive operation on the live streaming clip;
detect whether or not a user corresponding to the live streaming clip is in a live-streaming; and
based on the user being in a live-streaming, send an interactive operation record of the live streaming clip to the user, and/or display that the user is in the live-streaming in a live streaming interface of the live streaming clip.

9. The electronic device according to claim 8, wherein the processor is configured to:
acquire the live streaming clip of a current live streaming in response to an interception application request for the current live streaming; and/or
detect a current singing live streaming, and acquire the live streaming clip comprising a complete song live streaming clip in the current singing live streaming.

10. The electronic device according to claim 8, wherein the processor is configured to:
in response to the live streaming clip being a song live streaming clip, extract live streaming vocal audio from audio data of the live streaming clip; and
determine the score of the live streaming clip based on the live streaming vocal audio and the scoring mechanism.

11. The electronic device according to claim 8, wherein the processor is configured to:
acquire a latest on-demand record for the live streaming clip on a third-party electronic device corresponding to the on-demand request in response to receiving the on-demand request for the live streaming clip;
determine a stopping position of a previous audiovisual playing for the live streaming clip on the third-party electronic device based on the on-demand record; and
play the live streaming clip starting from the stopping position of the previous audiovisual playing continually.

12. (canceled)

13. The electronic device according to claim 8, wherein the processor further is configured to:
after displaying that the user is in the live-streaming in the live streaming interface of the live streaming clip, in response to receiving a trigger operation for a head portrait of the user of the live streaming clip, switch to a real-time live streaming interface of the user.

14. A non-transitory computer-readable storage medium having a computer instruction stored thereon, when the computer instruction being executed by a processor of the electronic device, enable the electronic device to implement a method for processing live streaming clips,
the method comprising:
acquiring an intercepted live streaming clip;
determining a score of the live streaming clip based on the live streaming clip and a scoring mechanism, said determining comprising determining the score of the live streaming clip based on popularity of the live streaming clip during a real-time live streaming;
presenting the live streaming clip based on the score of the live streaming clip;
playing the live streaming clip in response to receiving an on-demand request for the live streaming clip;
recording an interactive operation on the live streaming clip;
detecting whether or not a user corresponding to the live streaming clip is in a live-streaming; and
based on the user being in a live-streaming, sending an interactive operation record of the live streaming clip to the user, and/or displaying that the user is in the live-streaming in a live streaming interface of the live streaming clip.
